(19) United States
(12) Patent Application Publication
(10) Pub. No.: US 2019/0020377 A1
(43) Pub. Date: Jan. 17, 2019

(54) RADIO FREQUENCY IDENTIFICATION TAG AND RADIO FREQUENCY IDENTIFICATION SYSTEM

(71) Applicant: BOE TECHNOLOGY GROUP CO., LTD., Beijing (CN)

(72) Inventor: Feng JIANG, Beijing (CN)

(73) Assignee: BOE TECHNOLOGY GROUP CO., LTD., Beijing (CN)

(21) Appl. No.: 15/532,225

(22) PCT Filed: May 19, 2016
(86) PCT No.: PCT/CN2016/082612

§ 371 Date: Jun. 1, 2017

(30) Foreign Application Priority Data
Mar. 25, 2016 (CN) 201610180416.5

(51) Int. Cl. H04B 5/00; G06K 19/077; G06K 7/10

(52) U.S. Cl. CPC H04B 5/0062; G06K 7/10128; G06K 19/077

(57) ABSTRACT

The present disclosure provides a RFID tag and a RFID system. The RFID tag includes a first communication module, a data processing module and a RFID module. The first communication module is configured to establish a communication connection with an information collection device acquire information collected by the information collection device. The data processing module is connected to the first communication module and the RFID module, and configured to process the information collected by the information collection device and acquired by the first communication module, and output the processed information through the RFID module.

### CROSS-REFERENCE TO RELATED APPLICATION

The present application claims a priority of the Chinese Patent Application No. 201610180416.5 filed on Mar. 25, 2016, which is incorporated herein by reference in its entirety.

### TECHNICAL FIELD

The present disclosure relates to the field of radio frequency identification (RFID) technology, in particular to a RFID tag and a RFID system.

### BACKGROUND

Along the rapid development of the Internet of Things (IoT) technology, the demand on terminal devices will increase dramatically in future. As an identification card for each terminal device in the IoT era, the RFID technology has dominated the market due to its low manufacture cost and simple manufacture process. However, the conventional RFID technology may merely function as to identify an object, rather than to acquire and process information.

### SUMMARY

An object of the present disclosure to provide a RFID tag and a RFID system, so as to acquire, process and transmit information.

In one aspect, the present disclosure is to provide a RFID tag, including a first communication module, a data processing module and a RFID module. The first communication module is configured to establish a communication connection with an information collection device, so as to acquire information collected by the information collection device. The data processing module is connected to the first communication module and the RFID module, and configured to process the information collected by the information collection device and acquired by the first communication module, and output the processed information through the RFID module.

In a possible embodiment of the present disclosure, the RFID tag further includes a storage module connected to the data processing module and configured to store therein the information collected by the information collection device and acquired by the first communication module and the processed information.

In a possible embodiment of the present disclosure, the RFID tag further includes a power source module.

In a possible embodiment of the present disclosure, the power source module includes a battery and a charging unit connected to the battery.

In a possible embodiment of the present disclosure, the battery is a nickel-metal hydride battery or lithium-ion battery, and the charging unit is a wireless charging unit or solar energy charging unit.

In a possible embodiment of the present disclosure, the RFID module includes a RFID tag antenna and a RFID tag circuit. The RFID tag circuit includes a demodulator, a modulator, a logic control circuit and a storage integrated circuit (IC). The demodulator is connected to the RFID tag antenna and the logic control circuit, and configured to demodulate a signal received by the RFID tag antenna from the outside, and transmit the demodulated signal to the logic control circuit. The logic control circuit is connected to the modulator and the storage IC, and configured to decode the signal received by the demodulator, and transmit information stored in the storage IC to the modulator in accordance with information acquired after decoding. The modulator is connected to the RFID tag antenna, and configured to modulate a signal received by the logic control circuit, and transmit the modulated signal to through the RFID tag antenna.

In a possible embodiment of the present disclosure, the RFID tag circuit further includes a rectifier connected to the RFID tag antenna and configured to convert an alternating current (AC) RF signal received by the RFID tag antenna into a direct current (DC) RF signal, so as to apply an operating voltage to the RFID module.

In a possible embodiment of the present disclosure, the data processing module includes a processor and a clock connected to the processor and configured to provide an operating sequence for the processor.

In a possible embodiment of the present disclosure, the first communication module includes at least one of a Bluetooth communication unit and a Zigbee communication unit.

In another aspect, the present disclosure provides in some embodiments a RFID system including the above-mentioned RFID tag, an information collection device, and a RFID reader configured to receive information outputted from the RFID tag through the RFID module.

In a possible embodiment of the present disclosure, the first communication module of the RFID tag detects signal strength of the information collection device, to determine whether or not to establish a communication connection with the information collection device.

In a possible embodiment of the present disclosure, the RFID system further includes a control device configured to control the establishment of the communication connection between the first communication module and the information collection device in accordance with information inputted by a user.

In a possible embodiment of the present disclosure, the control device is further configured to write identification information of the RFID tag into the information collection device, to enable the establishment of the communication connection between the first communication module and the information collection device.

In a possible embodiment of the present disclosure, the information collection device includes a sensor, a digital-to-analog converter (DAC) and a second communication module. The DAC is connected to the sensor and the second communication module, and configured to convert information connected by the sensor from an analog signal into a digital signal and then output the digital signal through the second communication module.

In a possible embodiment of the present disclosure, the sensor includes at least one of a temperature sensor, a humidity sensor, a position sensor, a speed sensor and an image sensor.

In a possible embodiment of the present disclosure, the information collected by the information collection device includes at least one of speed information, characteristic information and position information, of a vehicle. The RFID tag is configured to analyze and process the information collected by the information collection device, and transmit an analyzing and processing result to a traffic monitor center through the RFID reader.

In a possible embodiment of the present disclosure, the RFID tag is further configured to transmit the analyzing and processing result to the vehicle through the information collection device.

In a possible embodiment of the present disclosure, the information collected by the information collection device includes at least one of temperature information about an environment where goods are located, humidity information about the environment where the goods are located, and position information about the goods. The RFID tag is further configured to analyze and process the information collected by the information collection device, and transmit an analyzing and processing result to a logistics monitor center through the RFID reader.

In a possible embodiment of the present disclosure, the information collected by the information collection device includes at least one of information about a person who buys a medicine, information about the medicine, information about a price of the medicine, and information about payment. The RFID tag is further configured to analyze and process the information collected by the information collection device, and transmit an analyzing and processing result to an automatic medicine dispensing system through the RFID reader.

According to the RFID tag in the embodiments of the present disclosure, the information collected by the information collection device may be acquired by the first communication module, and processed by the data processing module, and then outputted through the RFID module. As a result, the RFID tag may function as to identify an object and meanwhile acquire, process and transmit information.

### BRIEF DESCRIPTION OF THE DRAWINGS

FIG. 1 is a schematic view showing a RFID tag according to one embodiment of the present disclosure;

FIG. 2 is another schematic view showing the RFID tag according to one embodiment of the present disclosure;

FIG. 3 is a schematic view showing a RFID system according to one embodiment of the present disclosure;

FIG. 4 is a schematic view showing the communication between the RFID tag and an information collection device in the RFID system according to one embodiment of the present disclosure; and

FIG. 5 is a schematic view showing the communication between the RFID and a plurality of information collection devices in the RFID system according to one embodiment of the present disclosure.

### DETAILED DESCRIPTION OF THE EMBODIMENTS

The present disclosure will be described hereinafter in conjunction with the drawings and embodiments. The following embodiments are for illustrative purposes only, but shall not be used to limit the scope of the present disclosure.

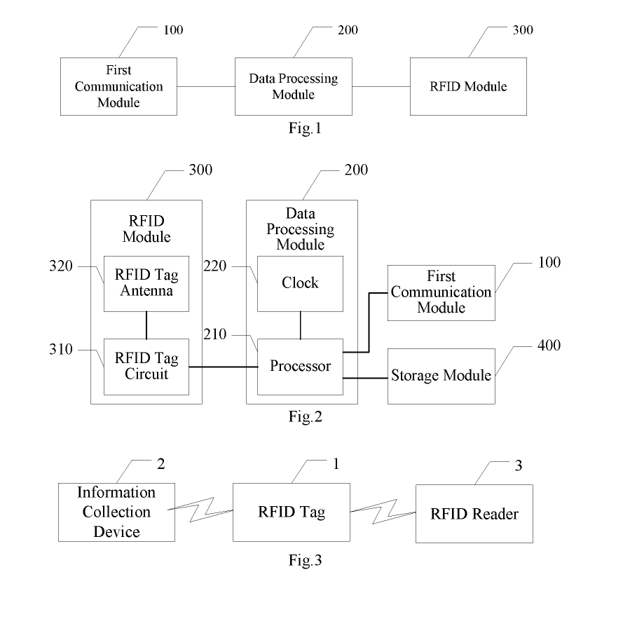

As shown in FIG. 1, which is a schematic view showing a RFID tag, the RFID tag includes a first communication module 100, a data processing module 200 and a RFID module 300. The first communication module 100 is configured to establish a communication connection with an information collection device, to acquire information collected by the information collection device. The data processing module 200 is connected to the first communication module 100 and the RFID module 300, and configured to process the information collected by the information collection device and acquired by the first communication module 100, and output the processed information through the RFID module 300.

According to the RFID tag in the embodiments of the present disclosure, the information collected by the information collection device may be acquired by the first communication module, and processed by the data processing module, and then outputted through the RFID module. As a result, the RFID tag may function as to identify an object and meanwhile acquire, process and transmit information.

A communication connection may be established between the RFID module of the RFID tag and a RFID reader, and the RFID module may include a RFID tag circuit and a RFID tag antenna.

In a possible embodiment of the present disclosure, the RFID tag may further include a storage module connected to the data processing module and configured to store therein the information collected by the information collection device and acquired by the first communication module and the processed information.

As shown in FIG. 2, which is another schematic view showing the RFID tag, the RFID tag includes the first communication module 100, the data processing module 200, the RFID module 300 and a storage module 400.

The first communication module 100 is configured to establish a communication connection with the information collection device, to acquire the information collected by the information collection device. For example, the first communication module 100 may include a Bluetooth communication unit and/or a Zigbee communication unit. Due to low power consumption, it is able for the above-mentioned communication mode to reduce the power supply pressure.

The data processing module 200 is connected to the first communication module 100 and the RFID module 300, and configured to process the information collected by the information collection device and acquired by the first communication module 100, and output the processed information through the RFID module 300. As shown in FIG. 2, the data processing module may include a processor 210 and a clock 220 connected to the processor 210 and configured to provide an operating sequence for the processor 210.

The RFID module 300 is configured to establish a communication connection with the RFID reader, and it may include an RFID rag circuit 310 and a RFID tag antenna 320. Usually, the RFID tag circuit 310 may include a demodulator, a modulator, a logic control circuit and a storage IC. The demodulator is connected to the RFID tag antenna and the logic control circuit, and configured to demodulate a signal received by the RFID tag antenna from the outside, and transmit the demodulated signal to the logic control circuit. The logic control circuit is connected to the modulator and the storage IC, and configured to decode the signal received by the demodulator, and transmit information stored in the storage IC to the modulator in accordance with information acquired after decoding. The modulator is connected to the RFID tag antenna, and configured to modulate a signal received by the logic control circuit, and transmit the modulated signal to through the RFID tag antenna. The modulator may modulate high-frequency oscillation with a low-frequency signal, and then transmit the modulated signal through the RFID tag antenna.

For the RFID tag, the data processing module may write to-be-transmitted information into the storage IC of the RFID module, so the to-be-transmitted information may be transmitted through the RFID module.

In a possible embodiment of the present disclosure, the RFID tag circuit 310 may further include a rectifier connected to the RFID tag antenna and configured to convert an AC RF signal received by the RFID tag antenna 320 into a DC RF signal, so as to apply an operating voltage to the RFID module. The storage module 400 is configured to store the information collected by the information collection device and acquired by the first communication module 100 and the processed information.

In a possible embodiment of the present disclosure, the RFID tag may further include a power source module, to provide electric power to the entire RFID tag. The power source module may include a battery and a charging unit connected to the battery and configured to charge the battery. The battery may be a conventional nickel-metal hydride battery, a conventional lithium-ion battery (in the case of a size of the RFID tag is not highly demanded), or a thin-film lithium-ion battery. The charging unit may be a wireless charging unit or solar energy charging unit. In addition, the power source module may be further provided with a super capacitor having a temporary energy-storage device, to function as a temporary power source in the case of no light or no wireless charging facility.

The present disclosure further provides in some embodiments a RFID system which, as shown in FIG. 3, includes the RFID tag 1, an information collection device 2, and a RFID reader 3 configured to receive information outputted from the RFID tag through the RFID module. In order to collect the information and establish the communication connection with the RFID tag, the information collection device 2 may include a sensor, a DAC and a second communication module. The DAC is connected to the sensor and the second communication module, and configured to convert information connected by the sensor from an analog signal into a digital signal and then output the digital signal through the second communication module.

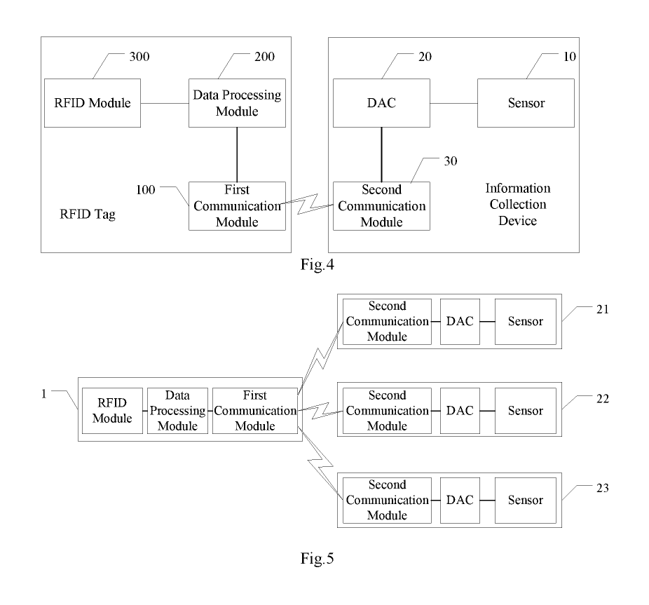

As shown in FIG. 4, the information collection device 2 may include a sensor 10, a DAC 20 and a second communication module 30. The second communication module 30 is configured to communicate with the RFID tag 1. Information collected by the sensor 10 is processed by the DAC, and then transmitted to the RFID tag 1 through the second communication module 30. Such a low-power-consumption communication mode as Bluetooth or Zigbee may also be adopted by the second communication module 30 of the information collection device 2.

For the above-mentioned RFID system, the communication connection between the RFID tag 1 and the information collection device 2 may be established as follows.

In a first mode, the RFID tag may initiatively search for signals from the neighboring information collection devices, and select (make a pair with) the information collection devices in accordance with signal strength. To be specific, the first communication module of the RFID tag may detect the signal strength of the information collection devices, and determine whether or not to establish the communication connection with the information collection device. For example, in the case that the first communication module of the RFID tag determines that the signal strength of one information collection device is greater than a predetermined threshold, it may establish the communication connection with the information collection device. In this way, it is able to reduce the labor cost.

In a second mode, an additional control device may be provided, i.e., the RFID system may further include a control device configured to control the establishment of the communication connection between the first communication module and the information collection device in accordance with information from a user. In other words, the first communication module may match the information collection device through the control device (e.g., a mobile phone). For example, after the RFID tag and the information collection devices are connected to the control device, the user may select the information collection devices to which the RFID tag is to be connected.

For example, the control device may be further configured to write identification information of the RFID tag into the information collection device, so as to enable the establishment of the communication connection between the first communication module and the information collection device. In use, the user may write, through the control device, the identify information of the RFID tag into the information collection device which the first communication module matches (the information collection device may be provided with corresponding signal processing and storage functions). During the matching procedure, the RFID tag may automatically match the information collection device where its identification information is stored. As compared with the first mode, it is able for this second mode to reduce the occurrence of a matching error.

In order to collect various kinds of information, the sensor of the information collection device may include at least one of a temperature sensor, a humidity sensor, a position sensor, a speed sensor and an image sensor.

The RFID system may include various information collection devices, and each information collection device may include various sensors. The communication connections may be established between the various information collection devices and the RFID tag simultaneously, so as to provide many kinds of information to the RFID tag. For example, various information collection devices may be mounted on a to-be-monitored object, so as to acquire various parameters (e.g., temperature, speed, position and humidity) of the to-be-monitored object. In addition, the RFID tag may be mounted on the to-be-monitored object or at a fixed position, so as to collect information about the parameters measured by these information collection devices, and then process, store and transmit the information.

As shown in FIG. 5, the communication connections may be established between the RFID tag 1 and an information collection device 21, an information collection device 22 and an information collection device 23 simultaneously. A sensor of the information collection device 21 may be a temperature sensor, a sensor of the information collection device 22 may be a humidity sensor, and a sensor of the information of the information collection device 23 may be a position sensor.

The above-mentioned RFID system may be applied to intelligent traffics, intelligent logistics and intelligent pharmacies.

In the case that the RFID system is applied to intelligent traffics, the information collected by the information collection device may include at least one of speed information, characteristic information and position information, of a vehicle. The RFID tag may be configured to analyze and process the information collected by the information collection device, and transmit an analyzing and processing result to a traffic monitor center through the RFID reader.

In addition, the RFID tag may be further configured to transmit the analyzing and processing result to a vehicle through the information collection device.

For example, the above-mentioned RFID tag may be mounted onto (e.g., attached to or embedded into) a traffic sign, and the information collection devices may be mounted onto vehicles. The RFID tag may collect information from the various information collection devices (e.g., information about speed, vehicle characteristics and personnel), and the information may then be analyzed by a processor in the RFID tag. Next, an analyzing result may be displayed on a display device of the traffic sign or transmitted through the corresponding information collection device to the vehicle, so as to monitor and guide the traffic flow and provide personalized information services. As a simple example, each vehicle that is driven through a position where a traffic sign with the RFID tag is located may transmit speed information to the RFID tag through the information collection device mounted therein. The RFID tag may determine, in accordance with the received information, whether or not the vehicle is being driven over a speed limit, and transmit feedback information to the vehicle, so as to prevent the vehicle from being driven over the speed limit. In addition, the RFID tag may be used to determine traffic information (the number of vehicles in unit time), so as to acquire information about road congestion ahead of the vehicle, thereby to guide the vehicles and prevent the occurrence of traffic jam. As a more personalized example, a large number of traffic signs with the RFID tags may be provided to form a network, so as to track each vehicle and provide travel information (e.g., information about accommodation, shopping and scenic spots) in real time.

In the case that the above-mentioned RFID system is applied to intelligent logistics, the information collected by the information collection device may include at least one of temperature information about an environment where goods are located, humidity information about the environment where the goods are located, and position information about the goods. The RFID tag may be further configured to analyze and process the information collected by the information collection device, and transmit an analyzing and processing result to a logistics monitor center through the RFID reader.

For example, a logistics control node with the RFID tag may be installed at a logistics channel, e.g., highway or warehouse. The logistics control node may receive and process logistics information collected by the information collection devices installed in the vehicles, so as to provide various information services for the vehicles and the logistics control center. The RFID system may be installed along the highway or in the warehouse. Similar to the above-mentioned intelligent traffic, in the case that the RFID system is applied to the highway, the logistics control nodes (with the above-mentioned RFID tag) may be used to monitor a movement track and speed of the vehicle (with the above-mentioned information collection device), so as to provide traffic information to the vehicle. In addition, for fresh-keeping logistics, the information collection device in the vehicle may transmit temperature and humidity information of the vehicle to the RFID tag, and the RFID tag may analyze and process the received information, so as to determine a fresh-keeping state of goods. The RFID tag may communicate with the logistics monitor center or any other terminal through the RFID reader, so as to transmit the information about the fresh-keeping state to the logistics monitor center or any other terminal in real time. Once abnormalities occur, a notification message may be transmitted to the vehicle through the logistics monitor center or any other terminal, so as to instruct a person in the vehicle to check and handle the situation in time. For warehousing, through the RFID system, it is able to provide an unattended warehouse. To be specific, after the vehicle enters the warehouse, the information collection device in the vehicle may transmit information about the goods to the RFID tag. Upon the receipt of the information, the RFID tag may calculate, and transmit to the vehicle, an unloading/depository position of the goods, and instruct other controllers in the warehouse to adjust the arrangement of the goods already in the warehouse in time for these new goods.

In the case that the above-mentioned RFID system is applied to intelligent pharmacies, the information collected by the information collection device may include at least one of information about a person who buys a medicine, information about the medicine, information about a price of the medicine, and information about payment. The RFID tag is further configured to analyze and process the information collected by the information collection device, and transmit an analyzing and processing result to an automatic medicine dispensing system through the RFID reader.

For example, the RFID tag may be installed in a hospital pharmacy, so as to enable buyers to buy and take medicines in an unattended, automatic manner. For example, basic information about the buyers may be written into the information collection device in advance, and in the case that the buyers carrying the information collection device enter a medicine-buying waiting area, the RFID tag may identify the information about a plurality of buyers simultaneously, including names and ages of the buyers, information about the medicines to be bought, information about a price of the medicine, and information about payment. After the information is identified, the processor in the RFID tag may process the purchase requests in chronological order of signal reception. For example, in the case that the information about payment indicates that the buyer has already paid the bill, the communication connection between the RFID tag and the automatic medicine dispensing system (e.g., a mechanical arm) through the RFID reader. The RFID tag may transmit a medicine dispensing instruction to the automatic medicine dispensing system. Then, the medicine may be delivered to a medicine dispensing window through the automatic medicine dispensing system, and the buyer may be reminded to take the medicine through broadcasting. In the case that the buyer has not paid the bill yet, the communication connection may be established between the RFID tag and the automatic medicine dispensing system (e.g., the mechanical arm) through the RFID reader. Then, the RFID tag may transmit a payment instruction to the automatic medicine dispensing system, and the automatic medicine dispensing system may prompt the buyer to pay the bill over the counter through broadcasting.

The above are merely the preferred embodiments of the present disclosure, but the present disclosure is not limited thereto. Obviously, a person skilled in the art may make further modifications and improvements without departing from the spirit of the present disclosure, and these modifications and improvements shall also fall within the scope of the present disclosure.

1. A radio frequency identification (RFID) tag, comprising a first communication module, a data processing module and a RFID module, wherein
the first communication module is configured to establish a communication connection with an information collection device to acquire information collected by the information collection device; and
the data processing module is connected to the first communication module and the RFID module, and configured to process the information collected by the information collection device and acquired by the first communication module, and output the processed information through the RFID module.

2. The RFID tag according to claim 1, further comprising a storage module connected to the data processing module and configured to store therein the information collected by the information collection device and acquired by the first communication module and the processed information.

3. The RFID tag according to claim 1, further comprising a power source module.

4. The RFID tag according to claim 3, wherein the power source module comprises a battery and a charging unit connected to the battery.

5. The RFID tag according to claim 4, wherein the battery is a nickel-metal hydride battery or lithium-ion battery, and the charging unit is a wireless charging unit or solar energy charging unit.

6. The RFID tag according to claim 1, wherein the RFID module comprises a RFID tag antenna and a RFID tag circuit;
the RFID tag circuit comprises a demodulator, a modulator, a logic control circuit and a storage integrated circuit (IC);
the demodulator is connected to the RFID tag antenna and the logic control circuit, and configured to demodulate a signal received by the RFID tag antenna from the outside, and transmit the demodulated signal to the logic control circuit;
the logic control circuit is connected to the modulator and the storage IC, and configured to decode the signal received by the demodulator, and transmit information stored in the storage IC to the modulator in accordance with information acquired after decoding; and
the modulator is connected to the RFID tag antenna, and configured to modulate a signal received by the logic control circuit, and transmit the modulated signal to through the RFID tag antenna.

7. The RFID tag according to claim 6, wherein the RFID tag circuit further comprises a rectifier connected to the RFID tag antenna and configured to convert an alternating current (AC) RF signal received by the RFID tag antenna into a direct current (DC) RF signal to apply an operating voltage to the RFID module.

8. The RFID tag according to claim 1, wherein the data processing module comprises a processor and a clock connected to the processor and configured to provide an operating sequence for the processor.

9. The RFID tag according to claim 1, wherein the first communication module comprises at least one of a Bluetooth communication unit and a Zigbee communication unit.

10. A radio frequency identify (RFID) system, comprising the RFID tag according to claim 1, the information collection device, and a RFID reader configured to receive information outputted from the RFID tag through the RFID module.

11. The RFID system according to claim 10, wherein the first communication module of the RFID tag is configured to detect signal strength of the information collection device to determine whether or not to establish a communication connection with the information collection device.

12. The RFID system according to claim 10, further comprising a control device configured to control the establishment of the communication connection between the first communication module and the information collection device in accordance with information from a user.

13. The RFID system according to claim 12, wherein the control device is further configured to write identification information of the RFID tag into the information collection device to enable the establishment of the communication connection between the first communication module and the information collection device.

14. The RFID system according to claim 10, wherein the information collection device comprises a sensor, a digital-to-analog converter (DAC) and a second communication module; and
the DAC is connected to the sensor and the second communication module, and configured to convert information connected by the sensor from an analog signal into a digital signal and then output the digital signal through the second communication module.

15. The RFID system according to claim 14, wherein the sensor comprises at least one of a temperature sensor, a humidity sensor, a position sensor, a speed sensor and an image sensor.

16. The RFID system according to claim 10, wherein the information collected by the information collection device comprises at least one of speed information, characteristic information and position information of a vehicle; and
the RFID tag is configured to analyze and process the information collected by the information collection device, and transmit an analyzing and processing result to a traffic monitor center through the RFID reader.

17. The RFID system according to claim 16, wherein the RFID tag is further configured to transmit the analyzing and processing result to the vehicle through the information collection device.

18. The RFID system according to claim 10, wherein the information collected by the information collection device comprises at least one of temperature information about an environment where goods are located, humidity information about the environment where the goods are located, and position information about the goods; and
the RFID tag is further configured to analyze and process the information collected by the information collection device, and transmit an analyzing and processing result to a logistics monitor center through the RFID reader.

19. The RFID system according to claim 10, wherein the information collected by the information collection device comprises at least one of information about a person who buys a medicine, information about the medicine, information about a price of the medicine, and information about payment; and
the RFID tag is further configured to analyze and process the information collected by the information collection device, and transmit an analyzing and processing result to an automatic medicine dispensing system through the RFID reader.
